(19) United States
(12) Patent Application Publication
(10) Pub. No.: US 2018/0324532 A1
(43) Pub. Date: Nov. 8, 2018

(54) HEARING SYSTEM AND HEARING APPARATUS

(71) Applicant: SIVANTOS PTE. LTD., Singapore (SG)

(72) Inventor: CHRISTOPH KUKLA, FORCHHEIM (DE)

(21) Appl. No.: 15/972,269

(22) Filed: May 7, 2018

(30) Foreign Application Priority Data
May 5, 2017 (DE) 102017207581.3

(51) Int. Cl. H04R 25/00

(52) U.S. Cl. CPC H04R 25/552

(57) ABSTRACT

A hearing system has a binaural hearing apparatus for supplying a user of the hearing system with a spatially positioned acoustic signal. The hearing system further includes a signal processing unit for generating the acoustic signal and a position sensor for determining a current position of the user. The acoustic signal is constructed such that it simulates for the user a spatially positioned virtual signal source in such a way that a position of the virtual signal source corresponds to a position of a destination of the user.

### CROSS-REFERENCE TO RELATED APPLICATION

This application claims the priority, under 35 U.S.C. § 119, of German application DE 10 2017 207 581.3, filed May 5, 2017; the prior application is herewith incorporated by reference in its entirety.

### BACKGROUND OF THE INVENTION

### Field of the Invention

The invention relates to a hearing system with a binaural hearing apparatus with a signal processing unit for generating an acoustic output signal which is constructed such that it simulates a spatially positioned virtual signal source to a user. The invention further pertains to such a hearing apparatus with a signal processing unit.

Such a hearing system is disclosed DE 10 2004 035 046 A1 and its counterpart patent application publication US 2006/0018497 A1.

The hearing system comprises a binaural hearing apparatus, in particular a binaural hearing aid device.

Hearing systems are in wide use nowadays. Hearing system here frequently refers to a hearing apparatus, for example headset, which is connected to a signal processing unit, for example a smartphone. The signal processing unit here generates acoustic signals, for example the speech of a telephone call partner, which is made available to a user of the hearing system with the aid of the hearing apparatus. In general a hearing system thus refers, for example, to an interconnection of a signal-generating unit and a signal-reproducing unit.

Hearing systems frequently comprise binaural hearing apparatuses. Binaural hearing apparatuses refer to hearing apparatuses, for example a headphone, for both ears, which send a signal both to the right ear and to the left ear of the user. Binaural hearing apparatuses are also typically used for persons whose hearing is damaged or impaired, in order to compensate for a hearing deficit. Binaural hearing apparatuses usually comprise for this purpose at least one microphone which receives acoustic signals, for example the voice of a conversation partner. The received signals are then amplified by an amplifier unit within the hearing apparatus and output through at least one loudspeaker, also known as the earpiece, to the user.

The advantage of the binaural hearing apparatus is that it is possible to generate a spatial signal. In other words, the person perceives an acoustic signal that is transmitted from a defined direction with his ears differently. For example, sound waves that are transmitted from a region to the left of the direction of view of the person reach the person's left ear more quickly than the right ear. This phase and time shift of the acoustic signal, in particular an evaluation of this in the human brain, allows the person to localize the acoustic signal. The person thus “hears” that the acoustic signal is transmitted from the region on the left.

With the help of measurements, these phase and time shifts can be determined, and can be described in a mathematical function, for example the so-called Head Related Transfer Function (HRTF). The HRTF comprises all the characteristic physical magnitudes to be able to localize the acoustic signal that it describes. To artificially generate a spatial acoustic signal, the phase and time shift is transmitted by means of the hearing apparatus to the respective ear of the user, who thus perceives the signal in such a way as if it were transmitted from a position in his surroundings.

The hearing aid system known from DE 10 2004 035 046 A1 and US 2006/0018497 A1 transmits acoustic signals to the user for information about settings and/or system states of the hearing aid system.

For this purpose the hearing aid system comprises two hearing aid devices that can be worn on the head, with the aid of which acoustic signals are transmitted to the left ear and to the right ear. The hearing system is designed in such a way that it transmits the signals to the left or the right ear with a phase and/or time displacement, whereby the user perceives the signal in such a way as if it had been generated by a virtual signal source positioned spatially in his surroundings.

An information content is assigned to the virtual signal sources. For example, the generation of virtual signal sources permits an acoustic indication of a battery charge state of the hearing aid system. An acoustic signal is here spatially positioned by means of a virtual signal source in such a way that its spatial height corresponds to the height of the battery charge state. To interpret the height of the acoustic signal, and thus of the acoustically indicated battery charge state, an acoustic scale is transmitted, for example in the form of a value range from “bottom left to top right”.

A binaural hearing aid system with a hearing aid device which generates virtual, spatially positioned signal sources for the selection of operating modes, so that a user can select an operating mode with the aid of head movements, is given in US 2014/0016788 A1.

The hearing aid device there generates at least two differently spatially positioned virtual signal sources by means of the HRTF. A sensor unit then determines the head movements and head alignment of the user. If the head alignment has an alignment in the direction of a virtual signal source, then a selection of this virtual signal source is made by means of a confirmation action, for example by a nod of the head of the user.

### SUMMARY OF THE INVENTION

It is accordingly an object of the invention to provide a hearing apparatus and a hearing system which overcome the above-mentioned and other disadvantages of the heretofore-known devices and methods of this general type and which provide a hearing system with increased utility for the user.

With the foregoing and other objects in view there is provided, in accordance with the invention, a hearing system, comprising:

a position sensor for determining a current position of a user of the hearing system;

a module for identifying a position of a location in an environment of the user; and

a binaural hearing apparatus having a signal processing unit for generating an acoustic output signal configured to simulate a spatially positioned virtual signal source to the user, the signal processing unit being configured such that a spatial position of the virtual signal source corresponds to a position of a given destination.

In other words, the novel hearing system comprises a binaural hearing apparatus with a signal processing unit for generating an acoustic output signal. In general, hearing apparatus refers to an apparatus, in particular device, for the output of sound, for example music and/or a voice, by means of at least one loudspeaker. Hearing apparatuses are, for example, headphones, headsets or, in particular hearing aid devices, for example implanted “in-ear-hearing-devices”, and in particular hearing aid devices of the type mentioned at the beginning.

The binaural hearing apparatus comprises at least two loudspeakers, wherein a loudspeaker is respectively assigned to one ear. The binaural hearing apparatus furthermore comprises at least one microphone, preferably at least one microphone per ear, for the acquisition of environmental noises.

Spatial hearing is enabled with the aid of the binaural hearing apparatus. Spatial hearing refers to the fact that an acoustic signal that is detected by one ear of a person is present, subject to phase shift and/or time delay, at the other ear of the person. The phase and/or time shift of the signal is interpreted by the person as a spatial positioning of the signal. It is thus possible for a person to assign acoustic signals spatially.

By means of the Head Related Transfer Function (HRTF) described at the beginning, the phase and/or time shift can be implemented in a device, for example a binaural hearing apparatus. It is thus made possible to generate an acoustic signal by means of the hearing apparatus, whose signal source appears for the user of the hearing apparatus to be located spatially in a region surrounding the user. In fact, however, the signal is generated directly in, at or in front of the ear of the user, and only the phase and/or time shift is simulated.

This is exploited in the generation of the output signal, so that the output signal generated is constructed such that it simulates a spatially positioned virtual signal source for a user. In other words, the user gets the impression that the acoustic output signal is transmitted from a spatially positioned signal source instead of from the signal processing unit. Since, however, this spatially positioned signal source does not truly exist, and is only simulated by the signal processing unit, it is referred to as a virtual signal source.

In general it is possible for people to recognize, on the basis of their “accumulated acoustic experience”, whether an acoustic signal is transmitted, for example, either from “the front side” or from “the rear side”. Healthy hearing uses the so-called pinna effect for this purpose. The pinna effect refers to a change in an originally transmitted sound caused by the pinna (ear muscle) together with visual impressions and experiences of the person.

The hearing system furthermore comprises a position sensor, for example a GPS sensor. A determination of the user's current position is made with the aid of the position sensor. Alternatively or in addition, position information is transferred to the hearing system for example by means of a smartphone connected to the hearing system. Present Bluetooth protocols, for example, comprise such position information.

The hearing system furthermore comprises a module for identifying a position of a location in the environment of the user. In the present case, the identification of a location particularly refers to informing the user about his surroundings, for example in respect of buildings or the geography of the environment of the user. In addition, location in the present case refers, on top of the known definition, for example also to buildings and/or geographic features of the environment of the user, for example a river in the environment of the user.

The signal processing unit is, in addition, designed such that the spatial position of the virtual signal source corresponds to the position of the location and/or a point of interest. As the term suggests, a point of interest (POI) refers in general to a location of interest to the user. Restaurants, hotels and important sights in an unfamiliar country and/or city are, for example, POIs for the user.

In other words, the current position of the user is compared with a position of the location. The signal processing unit then generates a phase-shifted and/or time-delayed acoustic output signal which it passes to the user by means of the binaural hearing apparatus. The phase shift and/or the time delay of the acoustic output signal generated is here selected such that, for the user, the acoustic output signal is transmitted from a spatially positioned virtual signal source whose position corresponds to the position of the location.

According to an expedient development, the module is an input unit for the specification of a position of the location, in particular of a POI. This enables the specification of user-specific locations, in particular POIs. For example, by means of the hearing system the user is enabled to specify restaurants and/or particular shops by means of the input unit, which are then subsequently “acoustically shown” to him by means of the hearing apparatus.

Preferably, a plurality of acoustic output signals are generated by means of the signal processing unit, each of which simulates a virtual signal source. The user here by obtains a “signal map” like a map or a roadmap which permits an orientation and/or extended information about the locations. Depending on his current position, the user can thus for example “hear” locations that he does not see, and can thus orient himself. Information is provided purely acoustically, for example by means of a tone that appears to come from the direction in which the user has specified a location through the input unit.

Expediently the module is designed for identifying the position of the location with the aid of a map of the environment. The hearing system is for example connected for this purpose with an online map service, or the hearing system comprises an internally stored map of the environment of the user.

According to a particularly preferred embodiment, an identification of the position of the location by the module takes place by means of the at least one microphone of the hearing apparatus. Environmental noises, for example the splashing of a river, are recorded for this purpose with the aid of the at least one microphone, and are conveyed to the user after acoustic processing. The recording takes place, for example, as a binaural sound recording with location resolution in the context of the normal operation of the hearing system. Acoustic processing in this case means, for example, that the splashing of the river is amplified and/or is used as an acoustic output signal to simulate a signal source positioned at the position of the river. The user thus receives information that a river is located in his surroundings, at the position of which a virtual signal source is arranged. Furthermore, for example, an “acoustic recognition” of objects or public places as well as assemblies of people is hereby also enabled. For example, an acoustic recording of children playing permits a localization of a children's' playground which is then represented to the user acoustically by the signal processing unit by means of a virtually placed signal source.

In order to familiarize the user with the different configurations of the various acoustic output signals and of the virtual signal sources positioned thereby, a training preferably takes place, for example in the context of a fitting session at an acoustic technician. Alternatively, the training takes place during operation of the hearing system by the user. The hearing system is, for example, connected for this purpose to virtual reality glasses which replay an environment to the user during the training in which virtual signal sources are positioned by the hearing system.

The advantage is to be seen in that in a simple manner the user is enabled to differentiate the type of the building with reference to the different acoustic output signals.

Preferably the signal processing unit is designed to output different acoustic output signals. The output signals here differ, depending on the properties of the location. Properties of the location refers in the present case for example to distinguishing objects at the location, in particular a type of the object, for example distinguishing between a building and an automobile, or, for example, determining the purpose of an object at the location, for example a distinction between a shop and a hospital. In other words, the signal processing unit has different acoustic output signals, which simulate the virtually positioned signal sources, for different objects within the environment of the user. Objects here refers, for example, to buildings, automobiles and/or geographic properties of the environment of the user, for example a river. The same objects that are located at different locations here, however, always have the same acoustic output signal. This means that, at virtually positioned signal sources that simulate, for example, restaurants, the user always hears the same output signal, which gives the user the possibility of having all the restaurants located in his environment displayed acoustically.

According to an expedient development, the signal processing unit is designed such that it permits in particular a time-dependent selection of the locations at which a virtually positioned signal source simulated by an acoustic output signal is output. The selection, in particular the time-dependent selection, is preferably configurable by the user, and requires, for example, at least one connection of the hearing system to a time provider, for example the clock function within a smartphone connected to the hearing system. Time-dependent selection here refers to a selection of the acoustically produced output signals such that for example in the morning on the way to work parking spaces, for example, are preferably acoustically represented to the user, whereas in contrast shops, for example, are preferably acoustically represented in the afternoon.

Furthermore, interference-free information of the user is also ensured. Interference-free here means that as a result of the simple configuration of the information, in terms of the provision of information, the user does not receive an “overload” of information and can, for example, concentrate on a conversation without also having to concentrate on the acoustic output signals as well.

According to an expedient embodiment, the signal processing unit is designed such that the virtual signal source is simulated by a speech-less acoustic output signal, in particular by a signal tone and/or a sequence of signal tones. Speech-less acoustic output signal means that preferably no sentences, in particular no sequences of words, and also in particular no individual words are output. Receipt of the information is further simplified by this. Due to the spatial positioning, the signal tone in particular is sufficient as a simulation of the virtual signal source, in order to inform the user of the location. This is advantageous in particular in connection with the use of the hearing system by persons who are older and/or are sensitive to noise and/or have damaged hearing. The spatial positioning of the virtual signal source, and thus the spatial “positioning” of the signal tone, is sufficient in terms of the information content. At the same time it is designed such that an “information overload” is prevented.

The signal processing unit is preferably designed such that the position of the virtual signal source has a fixed location, and is independent of the current position of the user. Through this, even when the user is moving, an extension of an information environment of the user by means of an “acoustic representation” is enabled, as well as an easier spatial orientation. Information environment here refers to a quantity of visual and, in particular, acoustic information within a natural, audible or visible environment of a person. “Acoustic representation” here means that the user generates the “signal map” through the generated virtual signal sources, on which the destinations are acoustically represented, analogously to a graphic representation of destinations on a map or roadmap.

In a preferred development, the hearing system is designed for navigation of the user to a destination. The navigation is done here in that the current position of the user is determined by means of the position sensor, for example by means of GPS. A comparison between the current position of the user and the position of the desired destination then takes place. To navigate the user to the destination, the signal processing unit preferably generates a plurality of virtual signal sources simulated by acoustic output signals. The virtual signal sources are here spatially positioned such that they correspond to the route to the destination, and thus guide the user without speech. The user is “offered” virtual signal sources following each other in sequence, which are distributed along a proposed path from the current location to the destination. This means that the user hears, for example, an acoustic output signal of a signal source in front of him, which allows him, for example, to follow a road. If the user should turn at a crossroads or junction in order to arrive at his destination, a new virtual signal source simulated by an acoustic output signal is “positioned” in the road into which the user should turn. Thus, for example, at the crossroads or junction, the user hears a new virtual signal source simulated by an acoustic output signal to his right, and turns. The user thus follows the virtually positioned signal source.

For example, instead of a spoken command to “turn into the next road on the right”, the user perceives a virtual signal source positioned in the next road junction on the right, which thus guides the user to turn right.

The user is thus piloted to his target successively by a sequence of virtual signal sources, without spoken commands.

The advantage of this development is a simplified extension of the user's information environment, without overloading him with information.

The signal processing unit is expediently designed such that a parameter, for example the volume of the acoustic output signal and/or the speed with which the sequence of signal tones of the acoustic output signal is replayed, varies depending on the current position of the user in relation to the location. A precise guidance to the destination in the navigation of the user to the destination is, for example, achieved in this way. The acoustic output signal becomes, for example, louder as the user moves towards the virtual signal source, and thus to the destination.

A selection of the destination is permitted with the aid of the input unit or, for example, a smartphone of the user. The selection is, for example, made by speech control and/or gesture control and/or contact control, preferably by means of a touchscreen or a keypad. When the destination is specified by means of the user's smartphone, this is, for example, preferably connected wirelessly to the signal processing unit, for example by means of Bluetooth.

The embodiment has the advantage that a simple selectability of the destination is enabled. Simultaneously, as a result of the possibility of setting up a wireless connection, a modularity and versatility in respect of a selection of the input unit is achieved.

According to a preferred embodiment, the hearing system comprises a detection unit which is designed to detect the orientation of the user's head. The detection of the orientation of the head is known. A method as is described in the above-mentioned DE 10 2004 035 046 A1 and US 2006/0018497 A1 is in particular used for detection of the orientation of the head. For that purpose, the prior publications are incorporated herein by reference.

According to a preferred development, the detection unit is designed for the detection of a movement, for example a rotation of the head. The signal source is, furthermore, designed such that the position of the virtual signal source with reference to the orientation of the head is compensated for in such a way that for the user the virtual signal source, and thus the destination, has a fixed location.

For detection of the movement acceleration sensors and/or sensors which operate according to the gyroscopic principle for example are arranged inside the hearing apparatus. A reference system is arranged “around” the head of the user for adaption of the position of the virtual signal source. In the present case, reference system refers to a system with the nature of a three-dimensional, Cartesian coordinate system, whose axes are each arranged orthogonal to one another, wherein one axis is defined as a connecting axis between the two ears of the user, so that the connecting axis comprises the two ears of the user as “points” of the axis. The head of the user is arranged at the origin of the reference system. A movement, in particular a rotation of the head, is describable within the reference system as an angle. If the user, for example, turns the head from a maximum position to the right—the user looks over his right shoulder—into a maximum deviation to the left—the user then looks over his left shoulder—the user thus rotates his head within the reference system through an angle of 180° to the left around a vertical axis arranged perpendicularly to the connecting axis and extending along the spinal column of the user.

In order to adapt the position of the virtual signal source with its fixed location in the reference system of the head of the user, the signal processing unit “shifts” the position of the virtual signal source through an angle which has the same value as the value of the angle through which the head of the user is turned. The “shift” of the position of the virtual signal source, however, takes place in a direction opposite to the direction of rotation of the head of the user. In accordance with the example described above, the signal processing unit “shifts” the position of the virtual signal source through an angle of 180° to the right. The vertical axis here again serves as the rotational axis.

In other words, the position of the virtual signal source “shifts” through movement and/or rotation of the head of the user by a value that is exactly the same value in the opposite direction and/or direction of rotation. Expressed simply: if the user turns his head to the right, the position of the virtual signal source “turns” to the left, and vice versa. In an analogous manner, the position of the virtual signal source shifts in the presence of a tilting movement and/or a combination of a rotational movement and tilting movement of the head of the user.

Through this, a position of the virtual signal source that has a fixed location, independently of a head movement or an orientation of the head of the user, is enabled. In addition, an orientation and/or navigation of the user in the information environment is simplified.

Expediently the hearing system has a connection to a database, for example on the Internet. The database preferably comprises information about the positions of locations. Alternatively, the database, in particular the information stored in it, is integrated internally into the hearing system, for example stored on a smartphone connected to the hearing system, for example as an app. In a similar manner, the hearing system comprises an external database, for example a hard disk. Furthermore, a configuration of multiple user profiles is permitted by means of the database, comprising user-specific (destination) locations and/or user-specific information about (destination) locations.

In accordance with a preferred development, the database is designed such that it can be managed by the user. This means that the user supplies the database, for example, with user-specific destinations and/or information about destinations which can be called up by the hearing system in operation. In this way a user-specific adaption of destinations and/or information about destinations is enabled. Information about destinations in the present case refers, for example, to opening times that depend on the time of day and/or information from social networks.

Expediently the signal processing unit is designed such that it overlays the acoustic output signals with environmental signals. Environmental signals here refers in general to sounds, for example engine sounds, tones, music and other sounds that arise in everyday situations, as well as speech. The signal processing unit does not completely suppress the environmental signals, so that through an embedding of the signal sources in the environmental signals, the user perceives an acoustic extension to his environment.

Through overlaying the acoustic output signal with the environmental signals, a natural perception of the signal sources arises for the user. In other words, through overlaying the acoustic output signal with the environmental signals, the signal sources are integrated in a user-friendly manner into the surroundings of the user.

In particular, the virtual signal sources are overlaid on the normal function of the hearing aid device. This means that the hearing aid device exhibits, for example, three operating modes, by means of which the overlay of the virtual signal sources with the environmental signals can be adjusted. In other words, for example, the hearing aid device has one operating mode by means of which a normal operation of the hearing aid device (in which the environmental signals are replayed with amplification to compensate for the user's hearing deficit) is implemented. In a second operating mode, the virtual signal sources are output in addition to the normal operation and the amplified replay of the environmental signals by the hearing aid device. The amplification of the environmental signals is, however, reduced in this operating mode. In a third operating mode, the amplification of the environmental signals is, for example, entirely suppressed, and the user only hears the virtual signal sources.

In accordance with a preferred development, the binaural hearing apparatus is designed as a hearing aid device. Hearing aid device refers to a device for supplying a person whose hearing is damaged or impaired, the person wearing the hearing aid device in particular continuously or most of the time in order to compensate for a hearing deficit.

In this way an improved supply of information about his surroundings is permitted to the user to compensate for and/or to improve on the hearing deficit by means of the spatially positioned signal sources. An advantage is in particular to be seen here for the user with damaged and/or impaired hearing as a result of the simulation of the signal source by a speech-free output signal. In other words, users with damaged or impaired hearing often perceive acoustic information, for example language and/or music, as disturbing or unnatural as a result of their limited hearing capacity. In general, the limited hearing of the user is overwhelmed, in particular at locations which have a large amount of acoustic information for the user. Locations which have large amount of acoustic information are, for example, a pedestrian zone in an inner-city, or an assembly of people, for example at a concert. By means of the spatially positioned signal sources, the user with damaged and/or impaired hearing experiences information about his surroundings without the user being overloaded by the information and/or feeling disturbed.

Alternatively or in addition, at least one ambient signal can be selected by means of the input unit by the user, which can be overlaid over the acoustic output signal. Ambient signal here refers to an acoustic signal which should support the user in his current state of mind, or should place the user into a specific state of mind. Ambient signal refers in particular to music and/or typical background sounds, for example the crackling of a fire. Preferably the input unit comprises a plurality of selectable programs, each of which comprises a different ambient signal. In a “good morning program,” for example, the acoustic output signal is overlaid with birdsong; in a “relaxation program,” the acoustic output signal is, for example, overlaid with the sounds of the ocean.

With the above and other objects in view there is also provided, in accordance with the invention, a hearing apparatus, comprising:

a signal processing unit for generating an acoustic output signal constructed to simulate a spatially positioned virtual signal source to a user;

the signal processing unit being configured such that a spatial position of the virtual signal source corresponds to a position of a specifiable destination.

In other words, the novel hearing apparatus is designed as a binaural hearing apparatus, and comprises a signal processing unit for the generation of an acoustic output signal. The output signal is of such a nature that it simulates a spatially positioned virtual signal source for a user. The signal processing unit is designed here such that a spatial position of the virtual signal source corresponds to the position of a specifiable destination.

The advantages described in relation to the hearing system and preferred embodiments are to be transferred analogously to the hearing apparatus, and vice versa.

Other features which are considered as characteristic for the invention are set forth in the appended claims.

Although the invention is illustrated and described herein as embodied in a hearing system and hearing apparatus, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings, which are in large part highly simplified illustrations.

### BRIEF DESCRIPTION OF THE SEVERAL VIEWS OF THE DRAWING

FIG. 1 a block diagram of a hearing system; and

FIG. 2 is a diagram virtual signal sources spatially positioned around a user.

Parts with the same function are shown with the same reference signs in the figures.

### DETAILED DESCRIPTION OF THE INVENTION

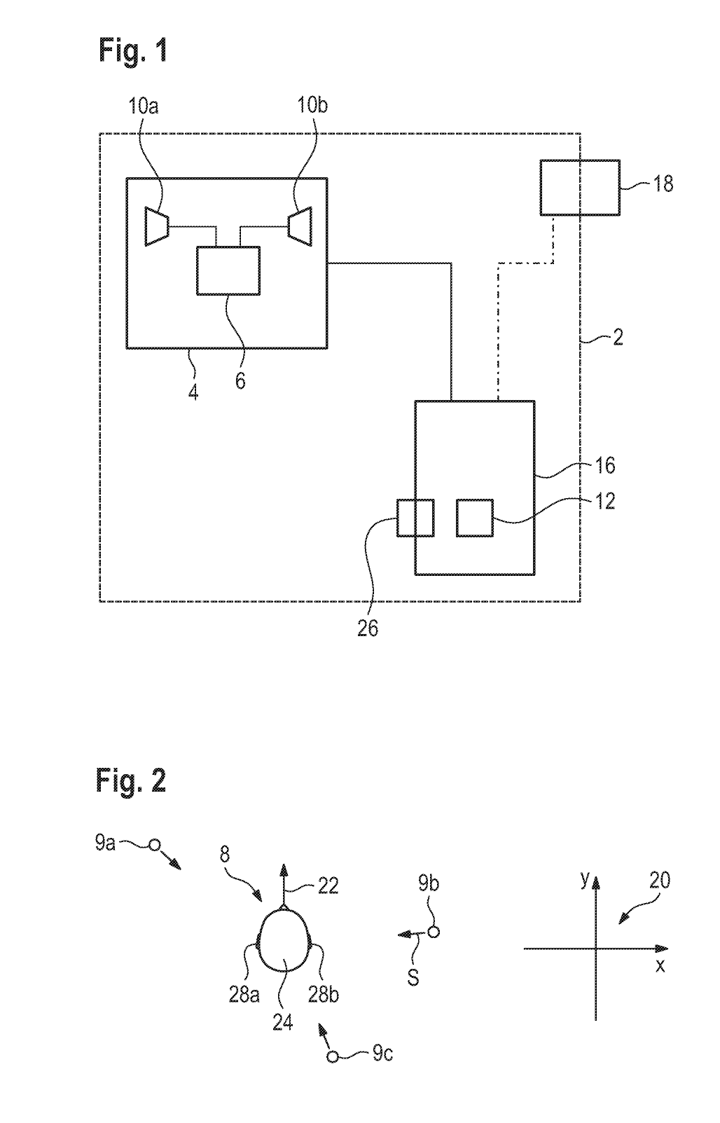

Referring now to the figures of the drawing in detail and first, particularly, to FIG. 1 thereof, there is shown a block diagram of a hearing system 2. In contrast with general language usage, the term hearing system 2 here refers to an arrangement of at least two apparatuses and/or units. The apparatuses and/or the units are, moreover, linked within the hearing system 2 for an exchange of data, preferably by way of a wireless connection, for example by way of a Bluetooth connection.

The hearing system 2 comprises a binaural hearing apparatus 4 with a signal processing unit 6 (SPU). Binaural hearing apparatus 4 refers in general to a hearing apparatus, for example a headphone, that is designed to supply both ears of a user 8 (see FIG. 2) with an acoustic signal. For this purpose, the binaural hearing apparatus 4 comprises at least two loudspeakers 10a, b, namely respectively at least one for the left ear and at least one for the right ear of the user 8. A binaural hearing apparatus refers in particular to a hearing aid device which is designed to support the hearing capacity of a person with impaired and/or damaged hearing.

The acoustic signal is generated by means of the signal processing unit 6 of the binaural hearing apparatus 4, and passed to the loudspeakers 10a, b, preferably by means of a conventional line, alternatively by means of a wireless connection, for example Bluetooth.

Alternatively or in addition, the binaural hearing apparatus 4 comprises two signal processing units 6, so that one signal processing unit 6 is arranged at each loudspeaker 10a, b. In the alternative embodiment, a communication between the two signal processing units 6 takes place by means of wireless connection, for example by means of Bluetooth.

A generation of a spatially positioned acoustic output signal S, referred to below as the acoustic signal S, is enabled by means of the signal processing unit 6 and of the binaural hearing apparatus 4. This means that an acoustic signal S is generated by means of the signal processing unit 6, and is then played by means of the binaural hearing apparatus 4 to the user 8, so that an impression arises in the user 8 that the acoustic signal S simulates a virtual signal source 9 (see FIG. 2) positioned spatially in the surroundings of the user 8. In other words, the user perceives the acoustic signal S in a manner as if it came from a direction, for example to the left, next to the user 8; although the acoustic signal S is played into, at or immediately in front of the two ears of the user 8.

With the aid of the signal processing unit 6, the phase shift and/or the time delay of the acoustic signal S can be simulated, so that by means of the binaural hearing apparatus 4, the acoustic signal S is conveyed to the two ears of the user 8 in such a way that the impression arises for the user 8 that he perceives a spatially positioned acoustic signal S. The phase-shifted and/or time-delayed acoustic signal S is here conveyed by means of the loudspeakers 10a, b, to, for example, the right ear of the user 8, and the acoustic signal S is conveyed to the left ear of the user. In the exemplary embodiment, the acoustic signal S is designed, in particular, as a speech-less acoustic signal S, for example as a signal tone.

In the exemplary embodiment, the generation of spatially positioned acoustic signals S is used in order to inform the user 8 about his surroundings. Inform here means that the signal processing unit 6 simulates spatially positioned virtual signal sources 9 by means of acoustic signals S, whose position corresponds to a position of a destination, for example a point of interest (POI) of the user 8.

For the purposes of positioning the virtual signal sources 9, a determination of a current position of the user is necessary as a reference position. For this purpose, the hearing system 2 has a position sensor 12, for example a GPS sensor, which is designed for determination of the current position of the user 8. In the present case, reference position refers to the current position of the user 8, so that the signal detection unit 4 “knows” on the one hand the spatial relationship in which it must position the virtual signal sources 9, and, on the other hand, whether the current position of the user 8 and/or his immediate surroundings comprise POIs at each of which a virtual signal source 9 can be positioned. Immediate surroundings refers, for example, to a region around the user 8 with a diameter having a value in the range of, preferably, a two-figure number of meters.

Alternatively or in addition, a positional determination and/or an optimization of the positional determination is permitted by means of acoustic information. For this purpose, the hearing apparatus 2 receives position signals, preferably from the position sensor 12, and compares these with current acoustic information which is received by means of at least one microphone arranged at the hearing apparatus 2. Acoustic information here refers to acoustic signals that contain information about a position. For example, the noise of an aircraft taking off supplies acoustic information that the user is located at or in an airport.

The hearing system 2 furthermore comprises an input unit 16, for example a smartphone, through which a selection of the destination is made by the user 8. The input unit 16 is, in the exemplary embodiment, preferably connected to the hearing system 2 with the aid of a wireless connection, for example Bluetooth. Alternatively the input unit 16 is integrated into the hearing system 2. The selection of the destination is made, for example, by means of voice and/or gesture control. Alternatively, the destination is selected in a contact-controlled manner, for example by means of a touch screen or a keypad.

In terms of the possibility of selecting different destinations, the hearing system 2 comprises at least one connection to a database 18, for example a user profile with the known characteristics of an account at an Internet portal. The database 18 comprises, on the one hand, various destinations and, on the other hand, information about the destinations, and can be managed by the user 8, so that user-specific destinations can be added to the database 18 and/or deleted from the database 18. For example, the management of the database 18 gives the user 8 the possibility of placing information about items being looked for, for example a T-shirt, into the database 18. If the user then moves, for example, along a road with a plurality of clothing shops, the hearing system 2 is designed to position for the user 8 a virtual signal source 9 at a position of a shop that carries the desired T-shirt in its range. The user 8 is thus simply informed in a purely acoustic manner, and does not have to expose himself to a large amount of information about the shops in order to find the T-shirt he is looking for. This design of the hearing system 2, however, requires, for example, a connection to the Internet for a data comparison, although this is realized by means of the smartphone connected to the hearing system 2. The hearing system 2 in the exemplary embodiment is, furthermore, designed such that by means of the connection to the database 18 and/or a connection for example to the Internet, user information is permitted that is dependent on the time of day and/or dependent on the location. This means that, for example, parking spaces are preferably acoustically “shown” to the user on his way to work, for example, by means of the virtually positioned signal sources, whereas, for example, when strolling along a shopping street, the user is preferably acoustically “shown” shops in the manner already described by means of the virtually positioned signal sources.

Alternatively or in addition, the input unit 16, which is the smartphone of the user 8 in the exemplary embodiment, comprises the database 18. The database 18 is here realized through an internal memory of the input unit 16. In this way an “all-in-one” design of the input unit 16 and the database 18 is achieved, which improves the operability for the user 8. Furthermore, a GPS sensor integrated within the input unit 16, for example within the smartphone, can also be used as the position sensor 12.

The user 8 thus selects preferred destinations, depending on his position, for example by means of an app within his smartphone. The signal processing unit 6 then “positions” virtual signal sources 9 at the positions of the destinations that the user 8 has previously selected. The destinations are thus acoustically linked into the surroundings of the user 8. This means that the user 8 receives information as to where the destinations are located in space, without, for example, having to look at a digital map. After a selection of the destinations, the smartphone can therefore be put away in a pocket, since the “provision of spatial information” is performed purely acoustically by means of the binaural hearing apparatus 4, for example by means of a headphone.

In addition to providing information to the user 8 by means of the hearing system 2, in the exemplary embodiment this is also designed for a navigation of the user 8, for example from his current position to a POI. For this purpose, the user 8 selects a POI, for example by means of the input unit 16, and through a comparison of the current position of the user 8 determined by means of the position sensor 12 and the position of the selected POI, a route guidance is prepared, preferably by means of the input unit 16, for example the smartphone of the user 8. In contrast to a description, known per se, of the route by speech signals and/or by means of visual signals, for example by means of arrows on a digital map of a smartphone, the route description in the exemplary embodiment takes place by means of spatially placed virtual signal sources 9a, b, c. The virtual signal sources 9a, b, c are positioned such that the acoustic signal S which simulates the virtual signal source 9 is “transmitted” from the direction in which the user 8 should move in order to reach the desired POI. For example, at a crossroads at which he should turn right into a destination road, the user 8 hears a virtual signal source 9 (which transmits a speech-less acoustic signal S) positioned “in” the destination road instead of a speech command.

A possibility is thus created that the user 8 can, for example during the navigation, converse with a third person without having to concentrate simultaneously on the voice of the third person and the speech commands of the navigation system.

In order to inform the user 8 about a distance from the destination, the signal processing unit 6, in cooperation with the position sensor 12, is designed such that the volume, for example, of the acoustic signal S changes when the user 8 moves towards the destination.

A plurality of virtual signal sources 9a, b, c which are positioned spatially with respect to a user 8 are illustrated in FIG. 2. A coordinate system 20 is furthermore illustrated, in a manner known per se, in FIG. 2 for the precise definition of directions and/or alignments required below. The coordinate system has an x-direction and a y-direction, extending orthogonally with respect to one another.

An alignment of the user 8, and thus his direction of view 22, extends in the exemplary embodiment in the y-direction.

A detection of the alignment of the head of the user 8, as well as a detection of movements of the head 24 of the user 8, is in particular essential for the spatial positioning of the virtual signal sources 9a, b, c. For the sake of simplicity, the head of the user 8 is referred to for short as the head 24 below.

The hearing system 2 comprises a detection unit 26, for example an acceleration sensor, for detection of the alignment and of the movements of the head 24. Alternatively or in addition, the detection unit 26 comprises a gyroscopic sensor.

The detection unit 26 detects the movements of the head 24, for example in and against the x-direction and/or y-direction, in particular a change in the alignment of a previous alignment of the head 24 with reference to an alignment of the head 24 after a movement. In other words, if at the beginning of a movement the head 24 is aligned in the y-direction (the user is looking in the y-direction), and the user 8 turns the head 24 such that after the movement the head 24 is aligned, for example, in the x-direction (the user is now looking in the x-direction), the detection unit in the exemplary embodiment detects a rotary movement of the head 24 through an angle with a value of 90° “to the right” (with reference to the alignment of the x-direction and y-direction of the coordinate system 20).

Similarly, the detection unit 26 also detects such changes of alignment with reference to a tilting movement of the head 24. Tilting movement here refers to a movement that takes place when the user 8 changes the direction of view 22 “upwards” or “downwards”, in other words looking “into the sky” or “down at the ground”. A detection of a combination of a tilting movement with a rotary movement of the head 24 by means of the detection unit 26 is, furthermore, also enabled. A combination of a tilting movement with a rotary movement here means for example a displacement of the direction of view 22 of the user 8 through a movement of the head 24 from “lower left” to “upper right”. The inclusion of a mobility of the pupils within the head 24 is omitted here for reasons of simplification.

Due to the fact that the virtual signal sources 9a, b, c simulated by the acoustic signal S have fixed locations, i.e. considered spatially—regardless of an alignment of the head—correspond to the position of a destination, the detection of the movement and thus the alignment of the head 24 is a crucial feature for an orientation of the user 8.

In other words, a virtual signal source 9b is, for example, positioned in the x-direction, and thus to the right of the user 8. The user 8 perceives the virtual signal source 9b “to the right of him” as a result of the binaural hearing apparatus 4. This means that, as was already described at the beginning, the signal processing unit 6 generates an acoustic signal S which is played to the left ear 28a of the user by means of the binaural hearing apparatus 4 phase-shifted and/or time-delayed. The right ear 28b of the user 8 hears the acoustic signal S unchanged, or only slightly phase-shifted and/or time-delayed.

If the user 8 turns his head 24, for example through an angle with a value of 90° to the left, so that the direction of view 22 is then opposed to the x-direction, the user 8 perceives the virtual signal source 9b as if it were positioned behind him. This means that the actual spatial position of the virtual signal source 9b has not changed, although its position in a reference system of the user 8 has “shifted” through an angle with a value of 90° opposite to the direction of rotation of the head 24. An adjustment of the positions of the spatially positioned virtual signal sources 9a, b, c in terms of the reference system of the head 24 thus takes place, so that a spatially constant position of the virtual signal sources 9a, b, c is in this way conveyed to the user 8.

This design enables an orientation of the user 8 on the basis of the virtual signal sources 9a, b, c.

Alternatively or in addition, the detection of the alignment and/or of the movement of the user 8 and/or of the head 24, is for example performed by means of the position determination and/or inclination sensors integrated into the smartphone of the user 8.

The following is a summary list of reference numerals and symbols, as well as the corresponding structure used in the above description of the invention:

2 Hearing system

4 Binaural hearing apparatus

6 Signal processing unit

8 User

9a, b, c Virtual signal source

10a, b Loudspeaker

12 Position sensor

16 Module

18 Database

20 Coordinate system

22 Direction of view

24 Head of the user

26 Detection unit

28a Left ear of the user

28b Right ear of the user

S Acoustic signal

1. A hearing system, comprising:
a position sensor for determining a current position of a user of the hearing system;
a module for identifying a position of a location in an environment of the user; and
a binaural hearing apparatus having a signal processing unit for generating an acoustic output signal configured to simulate a spatially positioned virtual signal source to the user, said signal processing unit being configured such that a spatial position of the virtual signal source corresponds to a position of a given destination.

2. The hearing system according to claim 1, wherein said module is an input unit configured to specify the position of the location.

3. The hearing system according to claim 2, wherein said module is configured for identifying the position of the location with the aid of a map of the environment.

4. The hearing system according to claim 2, comprising at least one microphone for recording environmental noises, and wherein said module is configured for identifying the position of the location with the aid of the environmental noises recorded by said at least one microphone.

5. The hearing system according to claim 1, wherein said signal processing unit is configured to output different acoustic output signals, and wherein the output signals are different in dependence on properties of the location.

6. The hearing system according to claim 1, wherein said signal processing unit is configured for time-dependent selection of the locations for which acoustic output signals are output.

7. The hearing system according to claim 1, wherein said signal processing unit is configured to simulate the virtual signal source by way of a speech-less output signal.

8. The hearing system according to claim 7, wherein the speech-less output signal is a signal tone.

9. The hearing system according to claim 1, wherein said signal processing unit is configured such that the position of the virtual signal source has a fixed location, independent of a current position of the user.

10. The hearing system according to claim 1, configured for navigation of the user to the destination.

11. The hearing system according to claim 10, wherein said signal processing unit is configured such that a parameter of the acoustic output signal varies depending on the current position of the user in relation to the destination.

12. The hearing system according to claim 2, wherein said input unit is configured to enable a selection of the destination by the user.

13. The hearing system according to claim 1, further comprising a detection unit for detecting an orientation of a head of the user.

14. The hearing system according to claim 13, wherein said detection unit is configured for detecting a movement of the head, and said signal processing unit is configured to adjust the position of the virtual signal source in relation to the orientation of the head such that the destination has a fixed location for the user.

15. The hearing system according to claim 1, further comprising a database containing information about positions of destinations, and a communications link for establishing a connection to said database.

16. The hearing system according to claim 15, wherein said database is configured to be managed by the user.

17. The hearing system according to claim 1, wherein said signal processing unit is configured to overlay the acoustic output signals with environmental signals.

18. The hearing system according to claim 1, wherein said binaural hearing apparatus is a hearing aid device.

19. The hearing system according to claim 2, wherein said input unit is configured to enable at least one ambient signal to be selected by the user which is overlaid with the acoustic output signal.

20. A hearing apparatus, comprising:
a signal processing unit for generating an acoustic output signal constructed to simulate a spatially positioned virtual signal source to a user;
said signal processing unit being configured such that a spatial position of the virtual signal source corresponds to a position of a specifiable destination.
